(19) United States
(12) Patent Application Publication
(10) Pub. No.: US 2026/0213684 A1
(43) Pub. Date: Jul. 23, 2026

(54) METHOD FOR DETERMINING AND/OR CALCULATING A ROTATIONAL SPEED AND AN ANGLE IN SENSORLESS DRIVES, AS WELL AS A COMPUTER PROGRAM AND A DEVICE

(71) Applicant: Schaeffler Technologies AG & Co. KG, Herzogenaurach (DE)

(72) Inventors: Erhard Hodrus, Achern (DE); Christian Eberle, Bühl (DE)

(21) Appl. No.: 19/140,870

(22) PCT Filed: Dec. 12, 2023
(86) PCT No.: PCT/DE2023/100962

§ 371 Date: Jun. 18, 2025

(30) Foreign Application Priority Data
Dec. 19, 2022 (DE) 102022133877.0
Jan. 10, 2023 (DE) 102023100387.9

(51) Int. Cl. H02P 21/18; H02P 21/24; H02P 25/03

(52) U.S. Cl. CPC H02P 21/18; H02P 21/24; H02P 25/03; H02P 2203/03; H02P 2203/09

(57) ABSTRACT

The invention relates to a method for determining a rotational speed and a rotor positional angle in sensorless drives, preferably in a sensorless operation of a permanently excited synchronous machine, wherein the calculation is based on a first voltage error (Δ_ud_1′) and a second voltage error (Δ_ud_2′) from an angle variation in ud, and based on a first voltage error (Δ_uq_1′) and a second voltage error (Δ_uq_2′) from a rotor speed variation in uq. The invention also relates to a computer program and a a control device.

### CROSS-REFERENCE TO RELATED APPLICATION

The present application is the U.S. National Phase of PCT Patent Application Number PCT/DE2023/100962, filed on Dec. 12, 2023, which claims priority to German Patent Application Number 10 2022 133 877.0, filed Dec. 19, 2022, and German Patent Application Number 10 2023 100 387.9, filed Jan. 10, 2023, the entire disclosures of which are incorporated by reference herein.

### TECHNICAL FIELD

The present disclosure relates to a method for determining and/or calculating a rotational speed and an angle in sensorless drives, preferably in a sensorless operation of a permanently excited synchronous machine, as well as to a computer program and a device, in particular a control unit, for carrying out the above-mentioned method.

### BACKGROUND

The literature contains a large number of methods that enable the operation of an electric motor without a rotor position encoder. In this regard, a distinction is made between two main classes. If the motor is rotating and sufficient counter-induced voltage is therefore available, a method based on the voltage equations of a permanently excited synchronous machine is usually proposed. The voltage is measured on one hand and determined using the model of the voltage equations, which includes the currents and motor parameters. A voltage error in d-q coordinates is then determined from the difference between the measured voltage and the voltage determined in the model. The required rotor positional angle Gamma and the rotational speed Omega must now be determined such that the voltage errors disappear.

In the prior art, an iterative method was proposed for this purpose which, starting from a solution for the rotor positional angle Gamma_[i−1] and the rotational speed Omega_[i−1] from the last calculation step [i−1], determines four additional voltage errors in d and q by varying both variables, Gamma_[i−1]+delta_Gamma, Gamma_[i−1]−delta_Gamma, Omega_[i−1]+delta_Omega, Omega_[i−1]-delta_Omega:

$$delta\_ud ( Gamma\_ [ i - 1 ] + delta\_Gamma , Omega\_ [ i - 1 ] + delta\_Omega ) ,$$

$$delta\_uq ( Gamma\_ [ i - 1 ] + delta\_Gamma , Omega\_ [ i - 1 ] + delta\_Omega ) ,$$

$$delta\_ud ( Gamma\_ [ i - 1 ] - delta\_Gamma , Omega\_ [ i - 1 ] - delta\_Omega ) ,$$

$$delta\_uq ( Gamma\_ [ i - 1 ] - delta\_Gamma , Omega\_ [ i - 1 ] - delta\_Omega ) ,$$

$$delta\_ud ( Gamma\_ [ i - 1 ] + delta\_Gamma , Omega\_ [ i - 1 ] - delta\_Omega ) ,$$

$$delta\_uq ( Gamma\_ [ i - 1 ] + delta\_Gamma , Omega\_ [ i - 1 ] - delta\_Omega ) ,$$

$$delta\_ud ( Gamma\_ [ i - 1 ] - delta\_Gamma , Omega\_ [ i - 1 ] + delta\_Omega ) ,$$

$$delta\_uq ( Gamma\_ [ i - 1 ] - delta\_Gamma , Omega\_ [ i - 1 ] + delta\_Omega ) .$$

In one calculation step, multiple iterations with a reduction of the delta_Gamma and delta_Omega values could be considered.

The method was later modified and simplified as follows:

$$delta\_ud ( Gamma\_ [ i - 1 ] + delta\_Gamma \_Omega \_ [ i - 1 ] ) ,$$

$$delta\_uq ( Gamma\_ [ i - 1 ] + delta\_Gamma \_Omega \_ [ i - 1 ] ) ,$$

$$delta\_ud ( Gamma\_ [ i - 1 ] - delta\_Gamma \_Omega \_ [ i - 1 ] ) ,$$

$$delta\_uq ( Gamma\_ [ i - 1 ] - delta\_Gamma \_Omega \_ [ i - 1 ] ) ,$$

$$delta\_ud ( Gamma\_ [ i - 1 ] , Omega\_ [ i - 1 ] + delta\_Omega ) ,$$

$$delta\_uq ( Gamma\_ [ i - 1 ] , Omega\_ [ i - 1 ] + delta\_Omega ) ,$$

$$delta\_ud ( Gamma\_ [ i - 1 ] , Omega\_ [ i - 1 ] - delta\_Omega ) ,$$

$$delta\_uq ( Gamma\_ [ i - 1 ] , Omega\_ [ i - 1 ] - delta\_Omega ) .$$

The new solution Gamma_i and Omega_i is now determined using the two-dimensional secant method. The solution of a non-linear equation system with two unknown variables thus yields the two unknown variables Gamma and Omega.

The second main class refers to methods that use an injection signal. These are not considered in the present disclosure.

### SUMMARY

The present disclosure is therefore based on the technical objective of providing a calculation or determination of a rotor speed/rotational speed and an angle/rotor positional angle during a sensorless operation of a permanently excited synchronous machine and integrating it into a control unit in such a way that the runtime of the calculation or determination in the control unit is shortened in comparison to the prior art.

The above object is achieved by the features of claim 1. In other words, the present disclosure relates to a method for calculating and/or determining a rotational speed and a rotor positional angle in sensorless drives, preferably in a sensorless operation of a permanently excited synchronous machine, wherein the calculation and/or determination is based on a first voltage error and a second voltage error from an angle variation in ud, and based on a first voltage error and a second voltage error from a rotor speed variation in uq.

The above-mentioned method makes it possible to operate an electric motor without using a rotor position encoder. This also has the advantage that the rotor position encoder and the cabling required therefor can be omitted. On the one hand, this saves costs, as fewer parts are required, and on the other hand, the space that is no longer needed can be used for other purposes.

In other words, a voltage is measured on one hand and determined via the model of voltage equations on the other. This includes the currents and motor parameters. A voltage error in d-q coordinates is then determined from the difference between the measured voltage and the voltage determined in the model. The required rotor positional angle Gamma and the rotational speed Omega are then determined such that the voltage errors disappear.

It is preferable if the determination and/or calculation of the rotor positional angle and the rotational speed is carried out by means of a first and a second linear interpolation.

The starting point for a linear interpolation is generally made up of two data or measured values, for example, and the aim is to find out what happens between these two values. Accordingly, linear interpolation involves searching for a linear function or straight line that runs through the data points.

It is advantageous if the rotor positional angle is determined from the first voltage error and the second voltage error by the first linear interpolation with the first voltage error and the second voltage error.

It is advantageous if the rotational speed is determined from the first voltage error and the second voltage error by the second linear interpolation with the first voltage error and the second voltage error.

It is preferable if the first voltage error is based on the sum of a rotor positional angle in a last calculation step and a rotor positional angle difference and a rotational speed in a last calculation step, in particular determined as follows:

$$Δ\_uq \_ 1 ( Gamma\_ [ i - 1 ] + Δ\_Gamma , Omega\_ [ i - 1 ] ) ,$$

wherein the constants are provided as follows:
Δ_ud_1 is the first voltage error in ud,
Gamma_[i−1] is the rotor positional angle in the last calculation step,
Δ_Gamma is the rotor positional angle difference, and
Omega_[i−1] is the rotational speed in the last calculation step.

It is advantageous if the second voltage error is based on the difference between a rotor positional angle in a last calculation step and an angular difference and a rotational speed in a last calculation step, in particular determined as follows:

$$Δ\_uq \_ 2 ( Gamma\_ [ i - 1 ] - Δ\_Gamma , Omega\_ [ i - 1 ] ) ,$$

wherein the constants are provided as follows:
Δ_ud_2 is the second voltage error in ud,
Gamma_[i−1] is the rotor positional angle in the last calculation step,
Δ_Gamma is the rotor positional angle difference, and
Omega_[i−1] is the rotational speed in the last calculation step.

It is advantageous if the first voltage error is based on a rotor positional angle in a last calculation step and a sum of a rotational speed in a last calculation step and a rotational speed difference, in particular determined as follows:

$$Δ\_uq \_ 1 ( Gamma\_ [ i - 1 ] , Omega\_ [ i - 1 ] - Δ\_Omega ) ,$$

wherein the constants are provided as follows:
Δ_uq_1 is the first voltage error in uq,
Gamma_[i−1] is the rotor positional angle in the last calculation step,
Omega_[i−1] is the rotational speed in the last calculation step, and
Δ_Omega is the rotor positional angle difference.

It is preferred if the second voltage error is based on a rotor positional angle in a last calculation step and a difference of a rotational speed in a last calculation step and a rotational speed difference, in particular determined as follows:

$$Δ\_uq \_ 2 ( Gamma\_ [ i - 1 ] , Omega\_ [ i - 1 ] - Δ\_Omega ) ,$$

wherein the constants are provided as follows:
Δ_uq_2 is the second voltage error in uq,
Gamma_[i−1] is the rotor positional angle in the last calculation step,
Omega_[i−1] is the rotational speed in the last calculation step, and
Δ_Omega is the rotor positional angle difference.

It is advantageous if the first voltage error and the second voltage error in ud are determined independently of the first voltage error and the second voltage error in uq.

In summary, the present disclosure has the advantage that performing two linear interpolations with only two values is simpler in terms of computational effort than the two-dimensional secant method known from the prior art. When calculating the errors or voltage errors according to the present disclosure, it is sufficient to determine only four values instead of eight as previously. This means that the calculation and/or determination is possible with a significantly lower runtime and computing effort when integrating the method into a control unit.

The object of the present disclosure can also be achieved by a computer program for carrying out the method according to any one of the preceding aspects.

Furthermore, the object of the present disclosure can also be achieved by a device, in particular a control unit, for carrying out the method according to any one of the above aspects.

It is advantageous if the function of the rotor encoder is transferred to a software function for which computing time and memory must be provided on a control unit of the motor.

Finally, the present disclosure relates to the use of the above-mentioned method for auxiliary units, such as hydraulic pumps, at higher rotational speeds, preferably in series.

The present disclosure is explained in more detail below with reference to figures without limiting the general concept of the disclosure.

### BRIEF DESCRIPTION OF THE DRAWINGS

FIG. 1 shows a graphical illustration of the non-linear equation system for determining the voltage errors of the prior art compared to the determination of the voltage errors according to the present disclosure;

FIG. 2 shows a graphical representation of the voltage errors in d-direction and q-direction; and

FIG. 3 shows a comparison of a rotor positional angle and a rotational speed according to the determination according to the prior art and according to the determination according to the present disclosure.

### DETAILED DESCRIPTION

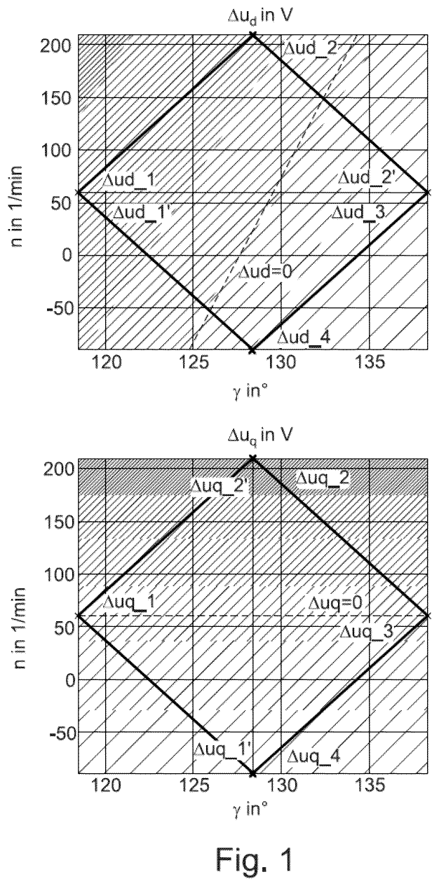

With reference to FIG. 1, the method for calculating and/or determining a rotational speed Omega_i and a rotor positional angle Gamma_i in sensorless drives, preferably in a sensorless operation of a permanently excited synchronous machine, is explained in more detail below.

FIG. 1 shows a graphical illustration of the non-linear equation system for determining the voltage errors Δ_ud_1, Δ_ud_2, Δ_ud_3 and Δ_ud_4 and Δ_uq_1, Δ_uq_2, Δ_uq_3 and Δ_uq_4 of the prior art compared to the determination of the voltage errors Δ_ud_1′ and Δ_ud_2′ and Δ_uq_1′ and Δ_uq_2′ according to the present disclosure.

FIG. 1 shows two diagrams. The upper diagram shows a coordinate system Δ_ud in V (volts) and the lower diagram shows a coordinate system Δ_uq in V (volts). Both coordinate systems have an x-axis, which shows the rotor positional angle in ° (degrees) and a y-axis, which shows the rotor speed/rotational speed in rpm. Thus, the equation for Δ_ud can be set up according to the left-hand diagram and the equation for Δ_uq according to the right-hand diagram on the basis of the values/voltage errors shown.

Accordingly, the optimized version of the approach used in the prior art uses four data points or voltage errors Δ_uq_1, Δ_uq_2, Δ_uq_3 and Δ_uq_4 for Δ_uq and four data points or voltage errors Δ_ud_1, Δ_ud_2, Δ_ud_3 and Δ_ud_4 for Δ_ud. In comparison, the method according to the present disclosure requires only two data points or voltage errors Δ_ud_1′ and Δ_ud_2′ as well as Δ_uq_1′ and Δ_uq_2′.

In both the upper diagram Δ_ud and the lower diagram Δ_uq of FIG. 1, the four data points mentioned above, or voltage errors Δ_ud_1, Δ_ud_2, Δ_ud_3 and Δ_ud_4 as well as Δ_uq_1, Δ_uq_2, Δ_uq_3 and Δ_uq_4 according to the prior art, are plotted and connected to each other by a line in each case, wherein this line forms a quadrilateral in both the lower diagram and the upper diagram.

The two above-mentioned data points or voltage errors Δ_ud_1′ and Δ_ud_2′ as well as Δ_uq_1′ and Δ_uq_2′ according to the present disclosure are also shown in the upper diagram Δ_ud as well as in the lower diagram Δ_uq of FIG. 1 and are connected to each other by a line, wherein the line in the upper diagram is substantially horizontal and the line in the lower diagram is substantially vertical.

The connecting line of Δ_ud_1′ and Δ_ud_2′ intersects the solution Δ_ud=0 in the upper image of FIG. 1, which is drawn there as a dashed (generally curved) line. Similarly, the connecting line of Δ_uq_1′ and Δ_uq_2′ intersects the solution Δ_uq=0 in the lower image of FIG. 1, which is also drawn there as a dashed (generally curved) line. The intersection point is the ideal solution, which is to be approximated by the linear interpolation in the respective calculation step.

There is a line for both Δ_ud and Δ_uq, which extends from a rotor angle of about 125° to about 135° in the upper diagram in FIG. 1 and is designated as Δ_ud=0. In the lower diagram in FIG. 1, Δ_uq=0 is a line that extends substantially horizontally at a rotational speed of about 60/min.

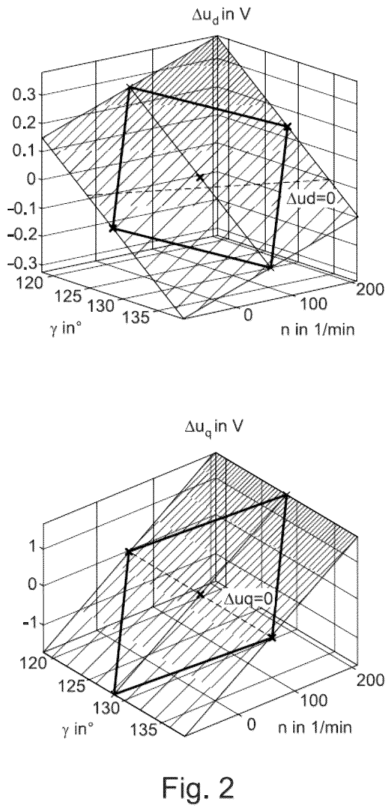

FIG. 2 shows a three-dimensional graphical representation of the voltage errors according to FIG. 1 in d-direction and q-direction.

FIG. 2 also shows two diagrams. The upper diagram again shows a coordinate system Δ_ud in V (volts) and the lower diagram again shows a coordinate system Δ_uq in V (volts). Both coordinate systems have an x-axis, which shows the rotor positional angle in ° (degrees) and a y-axis, which shows the rotor speed/rotational speed in rpm in n and a z-axis, which shows increments of 0.1 in Δ_ud and increments of 1 in Δ_uq. Both the points and connecting lines as well as the contour lines for Δ_ud=0 and Δ_uq=0 have been transferred to FIG. 2 in accordance with FIG. 1.

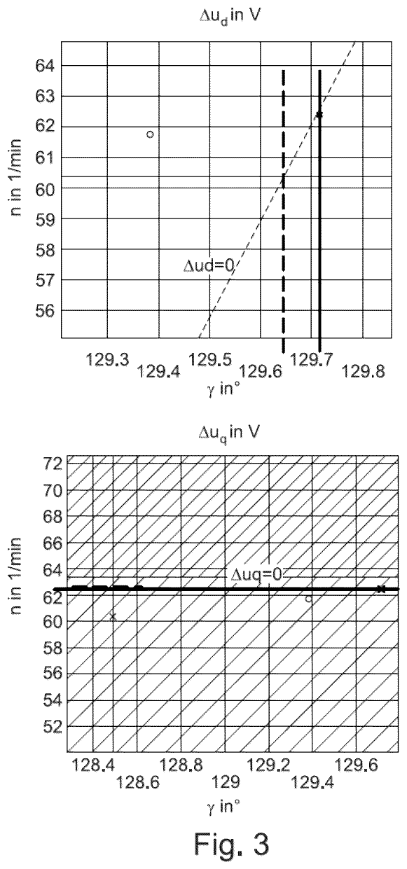

FIG. 3 shows a comparison of a rotor positional angle Gamma_i and a rotational speed Omega_i according to the determination according to the prior art and according to the determination/calculation according to the present disclosure.

FIG. 3 also shows two diagrams, wherein the upper diagram and the lower diagram also correspond to the diagrams in FIG. 1 with adjusted scaling.

In the upper diagram of FIG. 3, the contour lines are shown for Δ_ud=0 and as a vertical line at a rotor positional angle of slightly above 129.7° as a solution according to the optimized variant from the prior art and as a vertical, dashed line at a rotor positional angle between 129.6 and 129.7° as a solution according to the present disclosure. As a result, there is a rotor positional angle deviation of 0.1° electrically between the prior art solution and the solution according to the present disclosure.

In the lower diagram of FIG. 3, the contour lines are shown for Δ_uq=0 and as a horizontal line at a rotational speed of between 62 and 63 revolutions per minute as a solution according to the optimized variant from the prior art and as a horizontal, dashed line also at a rotational speed of between 62 and 63 revolutions per minute as a solution according to the present disclosure. As a result, there is no difference in rotational speed between the prior art solution and the solution according to the present disclosure.

1. A method comprising:
determining a rotational speed (Omega) of a rotor and a positional angle of the rotor (Gamma) based on a first voltage error (Δ_ud_1′) and a second voltage error (Δ_ud_2′) from an angle variation in ud and based on a first voltage error (Δu_q_1′) and a second voltage error (Δ_uq_2′) from a rotor speed variation in uq.

2. The method according to claim 1, wherein the determination of the rotor positional angle and the rotational speed is carried out by a first and a second linear interpolation.

3. The method according to claim 2, wherein the determination of the rotor positional angle (Gamma_i) from the first voltage error (Δ_ud_1′) and the second voltage error (Δ_ud_2′) is carried out by the first linear interpolation with the first voltage error (Δ_ud_1′) and the second voltage error (Δ_ud_2′).

4. The method according to claim 3, wherein the determination of the rotational speed (Omega_i) from the first voltage error (Δ_uq_1′) and the second voltage error (Δ_uq_2′) is carried out by the second linear interpolation with the first voltage error (Δ_uq_1′) and the second voltage error (Δ_uq_2′).

5. The method according to claim 4, wherein the first voltage error (Δ_ud_1′) is based on the sum of a rotor positional angle in a last calculation step (Gamma_[i−1]) and an angular difference (Δ_Gamma) and a rotational speed in a last calculation step (Omega_[i−1]).

6. The method according to claim 5, wherein the second voltage error (Δ_ud_2) is based on the difference of a rotor positional angle in a last calculation step (Gamma_[i−1]) and an angle difference (Δ_Gamma) and a rotational speed in a last calculation step (Omega_[i−1]).

7. The method according to claim 6, wherein the first voltage error (Δ_uq_1′) is based on a rotor positional angle in a last calculation step (Gamma_[i−1]) and a sum of a rotational speed in a last calculation step Omega_[i−1] and a rotational speed difference (Δ_Omega).

8. The method according to claim 7, wherein the second voltage error (Δ_uq_2′) is based on a rotor positional angle in a last calculation step (Gamma_[i−1]) and a difference of a rotational speed in a last calculation step Omega_[i−1] and a rotational speed difference (Δ_Omega).

9. A computer program for carrying out the method according to claim 1.

10. A a control unit for carrying out the method according to claim 1.

11. A method comprising:
determining, during operation of a permanently excited synchronous machine, a rotational speed of a rotor and a positional angle of the rotor based on a first voltage error and a second voltage error from an angle variation and based on a first voltage error and a second voltage error from a rotor speed variation.

12. The method according to claim 11, wherein the determination of the rotor positional angle and the rotational speed is carried out by a first and a second linear interpolation.

13. The method according to claim 12, wherein the determination of the rotor positional angle from the first voltage error and the second voltage error is carried out by the first linear interpolation with the first voltage error and the second voltage error.

14. The method according to claim 13, wherein the determination of the rotational speed from the first voltage error and the second voltage error is carried out by the second linear interpolation with the first voltage error and the second voltage error.

15. The method according to claim 14, wherein the first voltage error is based on the sum of a rotor positional angle in a last calculation step and an angular difference and a rotational speed in a last calculation step.

16. The method according to claim 15, wherein the second voltage error is based on the difference of a rotor positional angle in a last calculation step (and an angle difference and a rotational speed in a last calculation step.

17. The method according to claim 16, wherein the first voltage error is based on a rotor positional angle in a last calculation step and a sum of a rotational speed in a last calculation step and a rotational speed difference.

18. The method according to claim 17, wherein the second voltage error is based on a rotor positional angle in a last calculation step and a difference of a rotational speed in a last calculation step and a rotational speed difference.

19. A control unit comprising:
memory, wherein the memory is configured to maintain a computer program configured to determine, during operation of a permanently excited synchronous machine, a rotational speed of a rotor and a positional angle of the rotor based on a first voltage error and a second voltage error from an angle variation and based on a first voltage error and a second voltage error from a rotor speed variation.

20. The control unit according to claim 19, wherein the determination of the rotor positional angle and the rotational speed is carried out by a first and a second linear interpolation.
